(19) United States
(12) Patent Application Publication
(10) Pub. No.: US 2013/0185549 A1
(43) Pub. Date: Jul. 18, 2013

(54) ELECTRONIC DEVICE AND BIOS UPDATING DEVICE THEREOF

(71) Applicant: Chih-Wei Hu, New Taipei City (TW)

(72) Inventor: Chih-Wei Hu, New Taipei City (TW)

(73) Assignee: ASMedia Technology Inc., New Taipei City (TW)

(21) Appl. No.: 13/736,975

(22) Filed: Jan. 9, 2013

(30) Foreign Application Priority Data
Jan. 16, 2012 (TW) 101101570

(51) Int. Cl. G06F 9/44

(52) U.S. Cl. CPC G06F 9/4401
USPC 713/2

(57) ABSTRACT

An electronic device and a basic input/output system (BIOS) updating device thereof are provided. The electronic device includes a central processing unit (CPU), a chipset, a first interface circuit and a second interface circuit. The chipset is coupled to the CPU. The first interface circuit is coupled to a first memory and a second memory. The first memory includes a first BIOS file and the second memory includes a second BIOS file. The second interface circuit is coupled to the first interface circuit and an external storage device. When the external storage device includes a third BIOS file, a target memory is selected from the first memory and second memory according to a first rule and the target memory is updated using the third BIOS file. Thus, BIOS firmware of the electronic device can be safely updated.

### CROSS-REFERENCE TO RELATED APPLICATION

This application claims the priority benefit of Taiwan application serial No. 101101570, filed on Jan. 16, 2012. The entirety of the above-mentioned patent application is hereby incorporated by reference herein and made a part of specification.

### BACKGROUND OF THE INVENTION

1. Field of the Invention

The invention relates to an electronic device and, more particularly, to a basic input/output system (BIOS) updating device and an electronic device using the same.

2. Description of the Related Art

In a computer system, a motherboard usually includes a basic input/output system (BIOS) and the BIOS codes are stored in a BIOS memory. The BIOS memory is a non-volatile memory, such as a read-only memory (ROM). The central processor unit (CPU) is used to execute the BIOS codes stored in the BIOS memory first, that is, booting the computer system.

Currently, users can update the BIOS codes of the computer system. However, when the BIOS is abnormal (such as updating failure or update version error), the computer system cannot work. Thus, the computer needs to be sent to a repair station to detach the BIOS memory from the motherboard and burn the BIOS codes again.

Moreover, after the BIOS is updated, if the user regrets or does not satisfy with the updated BIOS, he or she cannot restore the BIOS to the original version since the original BIOS codes stored in the BIOS memory are eliminated. If the BIOS memory is erased and updated frequently, it shortens the working life of the BIOS memory.

### BRIEF SUMMARY OF THE INVENTION

A BIOS updating device includes a first interface circuit and a second interface circuit. The first interface circuit is coupled to a first memory and the second memory. The first memory includes a first BIOS file and the second memory includes a second BIOS file. The second interface circuit is coupled to the first interface circuit and an external storage device. When the external storage device includes a third BIOS file, a target memory is selected from the first memory and the second memory according to the first rule and the target memory is updated using the third BIOS file.

An electronic device includes a CPU, a chipset, a first interface circuit and a second interface circuit. The chipset is coupled to the CPU. The first interface circuit is coupled to a first memory and a second memory. The first memory includes a first BIOS file and the second memory includes a second BIOS file. The second interface circuit is coupled to the first interface circuit and an external storage device. When the external storage device includes a third BIOS file, a target memory is selected from the first memory and the second memory according to the first rule and the target memory is updated using the third BIOS file.

As stated above, the updating device is coupled to multiple memories. The updating device reads the third BIOS file from the external storage device of the electronic device via the second interface circuit. The second interface circuit selects a memory as the target memory according to the first rule, and the target memory is updated using the third BIOS file via the first interface circuit.

The third interface circuit selects a memory as the booting memory according to the second rule, and thus the chipset reads the BIOS file stored in the booting memory via the first interface circuit. Consequently, the updating device reduces the updating times of the memory to lengthen the working life, and avoid abnormal states due to updating version error. Additionally, the updating device restores the BIOS file to the original version when the user regrets or dissatisfies with the updated BIOS file, so as to update the memory safely.

These and other features, aspects and advantages of the present invention will become better understood with regard to the following description, appended claims, and accompanying drawings.

### BRIEF DESCRIPTION OF THE DRAWINGS

FIG. 1 is a block diagram showing an electronic device in an embodiment;

FIG. 2 is a flow chart showing that a BIOS file is loaded to a target memory; and

FIG. 3 is a flow chart showing that a chipset reads a BIOS file.

### DETAILED DESCRIPTION OF THE EMBODIMENTS

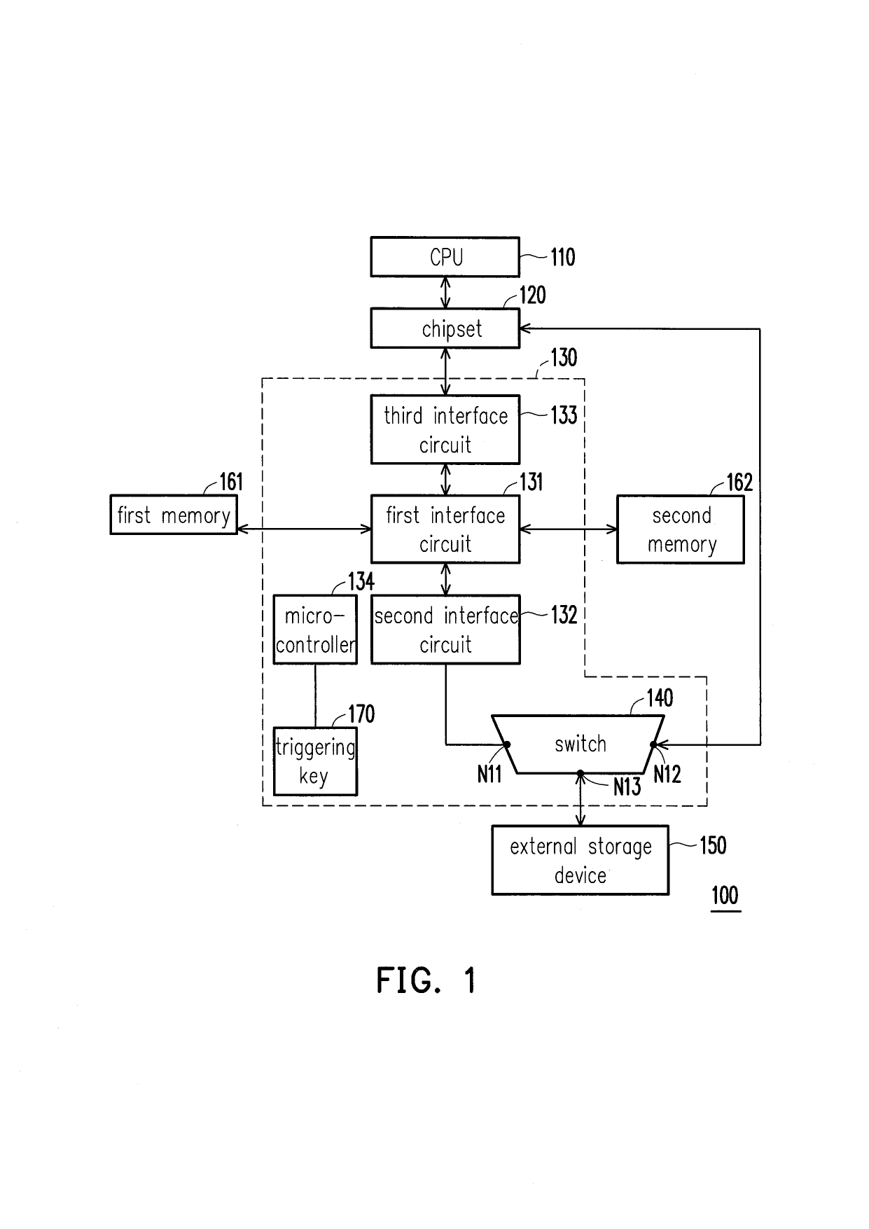

FIG. 1 is a block diagram showing an electronic device in an embodiment. The computer system 100 may include a BIOS. Please refer to FIG. 1. The computer system 100 includes a CPU 110, a chipset 120, an updating device 130, an external storage device 150 and multiple memories.

Although only a first memory 161 and a second memory 162 are shown in FIG. 1, the number of memories in the computer system 100 is not limited. The electronic device may include more memories according to practical requirements. The external storage device 150 includes a third BIOS file, and the first memory 161 includes a first BIOS file, and the second memory 162 includes a second BIOS file.

The updating device 130 includes a first interface circuit 131, a second interface circuit 132, a third interface circuit 133, a microcontroller 134, a switch 140 and a triggering key 170.

The first interface circuit 131 is coupled to multiple memories. For example, in the embodiment, the first interface circuit 131 is coupled to the first memory 161 and the second memory 162. The second interface circuit 132 is coupled to the first interface circuit 131. The second interface circuit 132 provides an access interface between the updating device 130 and the external storage device 150. The second interface circuit 132 loads the third BIOS file stored in the external storage device 150 to the first interface circuit 131.

The access interface provided by the second interface circuit 132 may be any data transferring interface. For example, if the external storage device 150 is a universal serial bus (USB) storage device, the second interface circuit 132 may be a USB controller. If the external storage device 150 is a Secure Digital (SD) memory card or a memory card of other kinds, the second interface circuit 132 may be a card reader circuit.

A first selecting end N11 of the switch 140 is coupled to the second interface circuit 132, a second selecting end N12 is coupled to the chipset 120, and a common end N13 is coupled to the external storage device 150.

The chipset 120 includes a normal operation state and a disabling state according to a power management mode of the computer system 100. When the computer system 100 boots and the chipset 120 is at the normal operation state, the switch 140 couples the external storage device 150 to the chipset 120. Thus, the external storage device 150 can be accessed by the operating system (OS) and application programs of the computer system 100.

The microcontroller 134 is coupled to the triggering key 170. The triggering key 170 may be a key inside the updating device 130 (as shown in FIG. 1), a key disposed outside the computer system 100 or a key at a keyboard.

When the computer system 100 is power off or at a sleep mode, the chipset 120 is at the disabling state. The user can press the triggering key 170 to trigger or enable the updating device 130 and the microcontroller 134. In the embodiment, the user should keep pressing on the triggering key 170 for three to five seconds, and the microcontroller 134 is enabled to execute the updating process, which avoids pressing by mistakes.

After the microcontroller 134 is enabled, the microcontroller 134 controls the switch 140 to couple the external storage device 150 to the second interface circuit 132. Thus, the external storage device 150 can be accessed by the updating device 130.

When the external storage device 150 connected to the second interface circuit 132 includes a BIOS file, the second interface circuit 132 selects the first memory 161 or the second memory 162 as a target memory according to the first rule, and the target memory is updated using the BIOS file stored in the external storage device 150 via the first interface circuit 131. In other words, when the chipset 120 is at the disabling state and the user presses the triggering key 170, the updating device 130 reads the BIOS file stored in the external storage device 150 via the second interface circuit 132.

The switch 140 may be omitted. That is, the external storage device 150 is coupled to the second interface circuit 132 directly.

The chipset 120 is coupled to the CPU 110. The third interface circuit 133 is coupled between the first interface circuit 131 and the chipset 120. The third interface circuit 133 provides an access interface between the first interface circuit 131 and the chipset 120.

The third interface circuit 133 of the updating device 130 selects the first memory 161 or the second memory 162 as a booting memory according to the second rule, and connects the booting memory to a connecting port of the BIOS memory of the chipset 120 via the first interface circuit 131.

For example, if the first memory 161 is selected as the booting memory, the first memory 161 is connected to the connecting port of the BIOS memory of the chipset 120 via the first interface circuit 131 and the third interface circuit 133. When the computer system 100 boots, the CPU 110 loads the first BIOS file (the BIOS firmware) stored in the first memory 161 via the chipset 120, the first interface circuit 131 and the third interface circuit 133 to process the booting process.

It assumes that the external storage device 150 stores the third BIOS file. When the second interface circuit 132 reads the third BIOS file stored in the external storage device 150, the microcontroller 134 (or the second interface circuit 132) checks the third BIOS file to determine whether the third BIOS file is valid to be adapted to the computer system 100.

For example, the microcontroller 134 control the second interface circuit 132 to execute a cyclic redundancy check (CRC) or check the name, format, date and version of the third BIOS file. The microcontroller 134 (or the second interface circuit 132) may also check whether the third BIOS file is adapted to the computer system 100. For example, the third BIOS file includes information suitable for the device type, and the microcontroller 134 (or the second interface circuit 132) checks the information to determine whether the third BIOS file can work at the computer system 100.

If the third BIOS file is valid, the microcontroller 134 controls the second interface circuit 132 to read the third BIOS file. That is, if the microcontroller 134 determines the third BIOS file stored in the external storage device 150 is valid and adapted to the computer system 100, the second interface circuit 132 selects the first memory 161 or the second memory 162 of the computer system 100 as the target memory according to the first rule.

In the embodiment, the selected target memory is different from the booting memory of the computer system 100. For example, if the current booting memory of the computer system 100 is the first memory 161, the microcontroller 134 (or the second interface circuit 132) should not select the first memory 161 as the target memory.

The first rule may be determined according to practical requirements. The first rule includes selecting the target memory according to numbers of executing update, size or version of the BIOS file.

For example, the first rule includes obtaining the numbers of executing update of the first memory 161 and the second memory 162, and selecting a memory which has fewer numbers of executing update from the first memory 161 and the second memory 162 as the target memory. The first interface circuit 131 may record the numbers of executing update of the first memory 161 and the second memory 162.

Thus, the second interface circuit 132 takes the obtained numbers of executing update of the first memory 161 and the second memory 162 as the first rule, and selects a memory which has fewer numbers of executing update from the first memory 161 and the second memory 162 as the target memory. Consequently, it can avoid the memory damage due to frequent updates. For example, if the numbers of executing update of the first memory 161 is larger than that of the second memory 162, the second interface circuit 132 would select updating the second memory 162 using the third BIOS file of the external storage device 150.

In another embodiment, the first rule includes obtaining version information of the first BIOS file stored in the first memory 161 and the second BIOS file stored in the second memory 162, and selecting a memory which stores a BIOS file of an older version from the first memory 161 and the second memory 162 as the target memory according to the version information. For example, if the version of the first BIOS file stored in the first memory 161 is newer than that of the second BIOS file stored in the second memory 162, the second interface circuit 132 selects updating the second memory 162 using the third BIOS file stored in the external storage device 150 to replace the second BIOS file stored in the second memory 162. If the version of the third BIOS file stored in the external storage device 150 is older than that of the first BIOS file stored in the first memory 161 and the second BIOS file stored in the second memory 162, the updating device 130 stops updating the first memory 161 and the second memory 162 using the third BIOS file of the oldest version.

The first rule may also include obtaining modification dates (or update dates) of the first memory 161 and the second memory 162, and selecting a memory with an earlier modification date from the first memory 161 and the second memory 162 as the target memory. The modification dates of the first memory 161 and the second memory 162 may be recorded in the first interface circuit 131 or recorded in the first memory 161 and the second memory 162, respectively.

Thus, the second interface circuit 132 retrieves the modification dates recorded in the first memory 161 and the second memory 162 and selects a memory with an earlier modification date from the first memory 161 and the second memory 162 as the target memory. For example, if the first memory 161 updated the BIOS firmware last week, the second memory 162 updated the BIOS firmware last year, and the second interface circuit 132 updates the second memory 162 using the third BIOS file of the external storage device 150 to replace the second BIOS file stored in the second memory 162.

The first rule is not limited to that in above embodiments. For example, the first rule may be achieved by a combination of the embodiments stated above. In other embodiment, the first rule may include: obtaining a first index from the third BIOS file of the external storage device 150; and selecting one of the first memory and the second memory as the target memory according to the first index. The target memory can be controlled by a first index. When the second interface circuit 132 updates the target memory using the third BIOS file stored in the external storage device 150, a light-emitting diode (LED) (not shown) of the computer system 100 gives out light to notice users that the third BIOS file stored in the external storage device 150 is written to the target memory successfully.

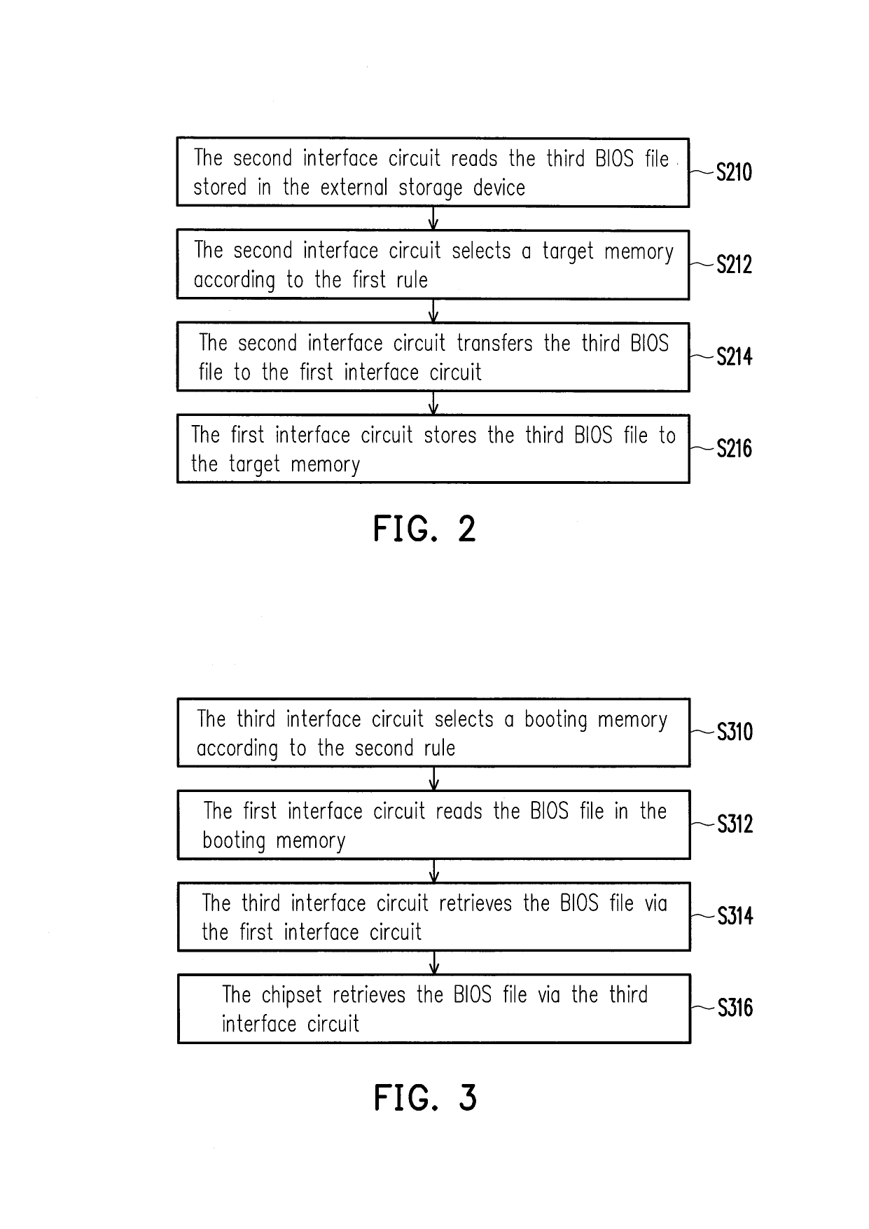

FIG. 2 is a flow chart showing that a BIOS file is loaded to the target memory. Please refer to FIG. 1 and FIG. 2, in step S210, the second interface circuit 132 reads the third BIOS file stored in the external storage device 150. In step S212, the second interface circuit 132 selects the first memory 161 or the second memory 162 as the target memory according to the first rule. In step S214, the second interface circuit 132 transfers the third BIOS file stored in the external storage device 150 to the first interface circuit 131. In step S216, the first interface circuit 131 stores the third BIOS file to the target memory.

Please refer to FIG. 1, the third interface circuit 133 selects the first memory 161 or the second memory 162 as a booting memory according to a second rule, and the chipset 120 reads the first BIOS file or the second BIOS file stored in the booting memory. The second rule may be determined according to practical requirements. For example, the booting memory is selected according to the target memory under the first rule or the version information.

The second rule includes selecting the first memory 161 or the second memory 162 as the booting memory according to the target memory selected by the first rule. For example, the updating device 130 may select a memory which has fewer numbers of executing update (such as the second memory 162) from the first memory 161 and the second memory 162 as the target memory according to the first rule.

Thus, the third interface circuit 133 selects the second memory 162 as the booting memory. In the first booting after the second memory 162 finishes updating, the CPU 110 reads the new BIOS file in the second memory 162 via the chipset 120 and the updating device 130 to execute the booting process. If the user dissatisfies with the new BIOS file stored in the second memory 162, or the new BIOS file results in a booting failure, the updating device 130 may select the first memory 161 as the booting memory in next booting.

In another embodiment, the second rule includes obtaining version information of the first BIOS file stored in the first memory 161 and the second BIOS file stored in the second memory 162, and selecting a memory which stores the BIOS file of a newer version from the first memory 161 and the second memory 162 as the booting memory.

The third interface circuit 133 takes the obtained version information of the first BIOS file stored in the first memory 161 and the second BIOS file stored in the second memory 162 as a basis of the second rule. For example, the updating device 130 selects a memory (such as the second memory 162) with a BIOS file of an older version from the first memory 161 and the second memory 162 as the target memory according to the first rule, and the third BIOS file of a latest version stored in the external storage device 150 is written to the second memory 162.

Since the second memory 162 stores the second BIOS file of a latest version, the third interface circuit 133 selects the second memory 162 as the booting memory. In the first booting after the second memory 162 finishes updating, the CPU 110 reads the new BIOS file in the second memory 162 via the chipset 120 and the updating device 130 to execute the booting process. If the user dissatisfies with the new BIOS file stored in the second memory 162, or the new BIOS file results in a booting failure, the updating device 130 may select the first memory 161 as the booting memory in next booting.

For example, FIG. 3 is a flow chart showing that the chipset reads a BIOS file in an embodiment. Please refer to FIG. 1 and FIG. 3, in step S310, the third interface circuit 133 selects the first memory 161 or the second memory 162 as the booting memory according to the second rule. In step S312, the first interface circuit 131 reads the BIOS file in the booting memory. In step S314, the third interface circuit 133 retrieves the BIOS file via the first interface circuit 131. In step S316, the chipset 120 retrieves the BIOS file via the third interface circuit 133.

The second rule is not limited to that in above embodiments. For example, the second rule may be achieved by a combination of the embodiments stated above.

In sum, the updating device and the electronic device read the BIOS file stored in the external storage device, and select the target memory from multiple memories according to specific rules to update the target memory using the BIOS file in the external storage device. Moreover, the updating device also selects the booting memory from multiple memories according specific rules, and the chipset boots the computer system according to the BIOS file stored in the booting memory. The specific rules may include numbers of executing update or version information recorded in the memories. Additionally, if the user confirms the BIOS file is valid after trying the BIOS file, the user may set the memory storing the BIOS file as the predetermined booting memory. If the user dissatisfies with the BIOS file, he or she can set another memory storing another BIOS file as the predetermined booting memory via a switching command Thus, the user can read the BIOS file from the external storage device, store the BIOS file to the electronic device with multiple memories to update the memories safely and try out the new BIOS file.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A basic input/output system (BIOS) updating device, comprising:
a first interface circuit coupled to a first memory and a second memory, wherein the first memory includes a first BIOS file and the second memory includes a second BIOS file; and
a second interface circuit coupled to the first interface circuit and an external storage device, wherein when the external storage device includes a third BIOS file, a target memory is selected from the first memory and the second memory according to a first rule, and the target memory is updated using the third BIOS file.

2. The BIOS updating device according to claim 1, wherein the second interface circuit includes a universal serial bus (USB) controller, and the external storage device is a USB storage device.

3. The BIOS updating device according to claim 1, wherein the second interface circuit includes a card reader, and the external storage device is a memory card.

4. The BIOS updating device according to claim 1, wherein the BIOS updating device further includes:
a switch including a first selecting end, a second selecting end and a common end, wherein the first selecting end is coupled to the second interface circuit, the second selecting end is coupled to a chipset, and the common end is coupled to the external storage device;
wherein if the chipset is at a normal operation state, the switch couples the external storage device to the chipset, and if the chipset is at a disabling state, the switch couples the external storage device to the second interface circuit.

5. The BIOS updating device according to claim 1, wherein the first rule includes selecting a memory which has fewer numbers of executing update, an older version, or an earlier modification date from the first memory and the second memory as the target memory which is updated using the third BIOS file.

6. The BIOS updating device according to claim 1, wherein the BIOS updating device further includes:
a third interface circuit coupled to the first interface circuit and a chipset, wherein the third interface circuit selects the first memory or the second memory as a booting memory according to a second rule.

7. The BIOS updating device according to claim 6, wherein the second rule is that taking the target memory as the booting memory.

8. The BIOS updating device according to claim 7, wherein the target memory is controlled by a first index.

9. The BIOS updating device according to claim 6, wherein the second rule is that the booting memory is selected from the first memory and the second memory which has a latest version.

10. The BIOS updating device according to claim 1, wherein the BIOS updating device further includes a triggering key and a microcontroller, and when the triggering key is enabled, the microcontroller controls the second interface circuit to select the first memory or the second memory as the target memory according to the first rule, and controls the external storage device including the third BIOS file to update the target memory via the second interface circuit.

11. An electronic device, comprising:
a central processing unit (CPU);
a chipset coupled to the CPU;
a first interface circuit coupled to a first memory and a second memory, wherein the first memory includes a first BIOS file and the second memory includes a second BIOS file; and
a second interface circuit coupled to the first interface circuit and an external storage device, wherein when the external storage device includes a third BIOS file, a target memory is selected from the first memory and the second memory according to a first rule, and the target memory is updated using the third BIOS file.

12. The electronic device according to claim 11, wherein the second interface circuit includes a USB controller, and the external storage device is a USB storage device.

13. The electronic device according to claim 11, wherein the second interface circuit includes a card reader, and the external storage device is a memory card.

14. The electronic device according to claim 11, wherein the electronic device further includes:
a switch including a first selecting end, a second selecting end and a common end, wherein the first selecting end is coupled to the second interface circuit, the second selecting end is coupled to the chipset, and the common end is coupled to the external storage device;
wherein if the chipset is at a normal operation state, the switch couples the external storage device to the chipset, and if the chipset is at a disabling state, the switch couples the external storage device to the second interface circuit.

15. The electronic device according to claim 11, wherein the first rule includes selecting a memory which has fewer numbers of executing update, an older version, or an earlier modification date from the first memory and the second memory as the target memory which is updated using the third BIOS file.

16. The electronic device according to claim 11, wherein the electronic device further includes:
a third interface circuit coupled to the first interface circuit and the chipset, wherein the third interface circuit selects the first memory or the second memory as a booting memory according to a second rule.

17. The electronic device according to claim 16, wherein the second rule is that taking the target memory as the booting memory.

18. The electronic device according to claim 17, wherein the target memory is controlled by a first index.

19. The electronic device according to claim 16, wherein the second rule is that the booting memory is selected from the first memory and the second memory which has a latest version.

20. The electronic device according to claim 11, wherein the electronic device further includes a triggering key and a microcontroller, and when the triggering key is enabled, the microcontroller controls the second interface circuit to select the first memory or the second memory as the target memory according to the first rule, and controls the external storage device including the third BIOS file to update the target memory via the second interface circuit.
